(19) United States
(12) Patent Application Publication
(10) Pub. No.: US 2009/0289900 A1
(43) Pub. Date: Nov. 26, 2009

(54) GAME WORLD MANIPULATION

(75) Inventors: Ehud Lavski, Herzelia (IL); Yael Dror, Ramat-Gan (IL); Asaf Barzilay, Tel Aviv (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: SAMSUNG ELECTRONICS CO., LTD., Gyeonggi-do (KR)

(21) Appl. No.: 12/123,570

(22) Filed: May 20, 2008

(51) Int. Cl. G06F 3/041

(52) U.S. Cl. 345/173

(57) ABSTRACT

A method of actuating a computer program that generates a dynamically changing graphic object on a touch screen using a human finger, comprises identifying the object or the portion of an object which is being touched by said finger and thereafter virtually “attaching” said object or portion thereof to said finger so that a movement of said finger causes a change of shape, size or location of said object or portion thereof.

### FIELD OF THE INVENTION

The present invention relates to the field of graphic applications. More particularly, the invention relates to the direct interaction of the user of a mobile communication device, such as a cellular phone, with a graphic program displayed on a touch screen.

### BACKGROUND OF THE INVENTION

Most games give the player a very limited sense or control and interaction through a game controller or keyboard and mouse control scheme. To this day no game offers direct manipulation of the game world through interaction with the user's finger.

Particularly, although touch screens have become popular in various devices, most applications still require the use of a stylus to operate various functions through it. Furthermore, operating a game via a keyboard, a mouse or a stylus, provides an altogether different user experience than when the user is able to interact with the game directly through his finger. The term “game”, as used herein, is meant to indicate not only games that can be played on a portable device, but also any other similar program with important graphic components, such as may be, for instance, a screensaver, although one of the primary purposes of this invention relates to its use on portable mobile device, particularly cellular telephones.

Another disadvantage of prior art games is that the touch screen is not used to manipulate elements within the game and to make changes to the game world. For instance, the “Loco roco” game (http://www.locoroco.com) operates such that in the game the user tilts the game world left and right to make a character advance in the direction of the ground's slope. The game does not use the touch screen for interaction. The game only lets the user tilt the entire game world and not to alter its terrain. In another example, the Nintendo DS, the player uses a stylus to interact with the game characters and world. There is no direct manipulation of the game world. This limits the feeling of direct interaction offered by dragging and manipulating the game world itself.

It is an object of the present invention to provide a solution that uses a touch screen and the player's fingers as a control device to deliver a level of interaction and manipulation that is not available in prior art games.

### SUMMARY OF THE INVENTION

The invention relates to a method of actuating a computer program that generates a dynamically changing graphic object on a touch screen, using a human finger, comprising identifying the object or the portion of an object which is being touched by said finger and thereafter virtually “attaching” said object or portion thereof to said finger so that a movement of said finger causes a change of shape, size or location of said object or portion thereof. By “attaching” it is meant to indicate that the position of the finger on the touch screen is continuously monitored and the coordinates of the pixel(s) originally touched by the finger (or by its center of gravity) are moved essentially in the same way that the coordinates of the finger (or its center of gravity) move. The operation of touch screens in relation to a processor that controls the graphics displayed thereon is well known in the art of displays and, therefore, such operations need not be described in detail herein, it being understood that technical steps not discussed herein are within the skill of the routineer.

According to a preferred embodiment of the invention identifying the object or the portion of thereof comprises identifying the center of gravity of all the pixels of the touch screen, which are touched by the finger, and using said center of gravity as the anchoring point for performing the virtual attachment of the object to the finger. This process is carried out by any of the methods well known to persons skilled in the art and is therefore not discussed here in detail, for the sake of brevity.

### BRIEF DESCRIPTION OF THE DRAWINGS

In the drawings:

FIGS. 1 and 2 schematically illustrate the use of the invention in the “Line game”, with a “mountain obstacle”;

FIGS. 3 and 4 schematically illustrate the use of the invention in the “Line game”, with a “hole obstacle”;

FIGS. 5 and 6 schematically illustrate the use of the invention in the “Line game”, with a “flying enemy obstacle”;

FIGS. 7 and 8 schematically illustrate the use of the invention in the “Line game”, with a “rolling rock obstacle”; and

FIGS. 9 and 10 schematically illustrate the use of the invention in the “Line game”, with a “gap obstacle”.

### DETAILED DESCRIPTION OF PREFERRED EMBODIMENTS

The invention uses a touch screen and the player's fingers as a control device, giving the user direct control and a way of manipulating the game world. The user manipulates and controls the game world and terrain itself, having the freedom to drag the world around, change the terrain's properties and twist the world in all directions in a 360 degrees angle. All the above will become even more evident through the following description of one illustrative game that employs the invention.

### EXAMPLE

### The Samsung Game ‘Lineman’

Lineman is a game designed for mobile phones that posses a touch screen. In the game the player uses his fingers' movement on a touch screen to directly manipulate the game world. This creates a new form of interaction with a game.

The Lineman game, which will be described in greater details hereinafter, is a 2D game in which a character walks across the screen at a constant pace. A line the character walks on represents the manipulatable game terrain. Obstacles pop up in the character's path. These include (in an exemplary game):

### Enemies;

### Holes;

### Mountains;

Rolling rocks; and

### Cliffs.

The character moves independently of the user. According to the rules of this exemplary game, the user needs to manipulate the game's terrain in order to help the character reach the end of the level. If the user fails to remove or avoid an obstacle, the character will bump into it and fail in that level.

When the user's finger is on the line, the line “attaches” itself to the movement of the finger. The user can then drag the line up or down, sideways and in every direction. The user's gestures create the terrain's movement and the way in which the obstacle is removed or avoided.

If a user disposes of or avoids all the enemies and obstacles in a level he will reach the end of the level. The game is composed of several levels.

### Obstacles and Gestures:

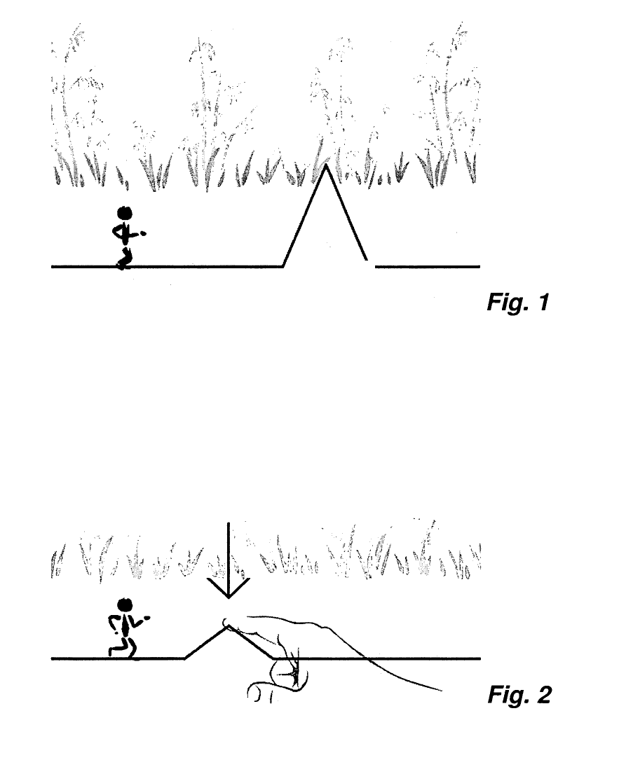

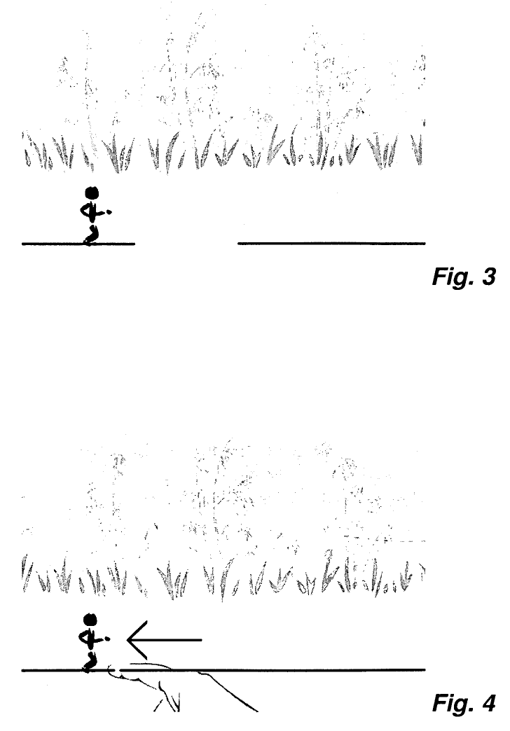

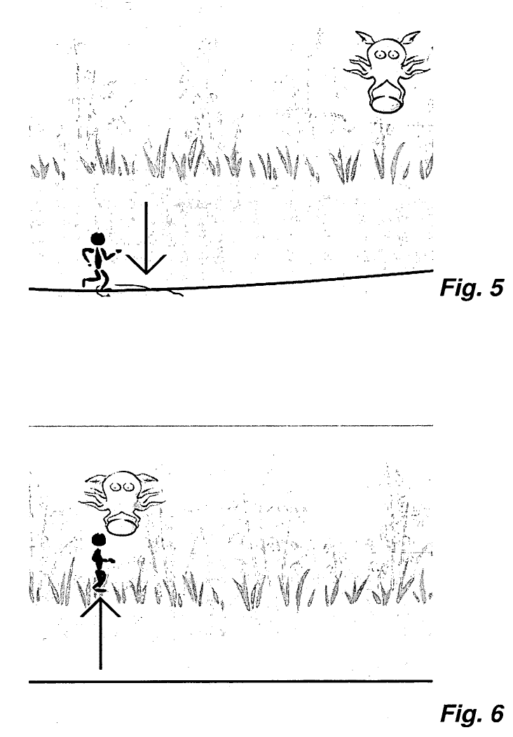

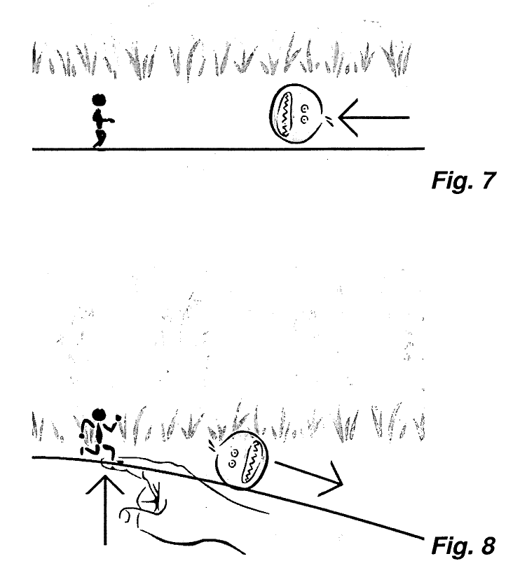

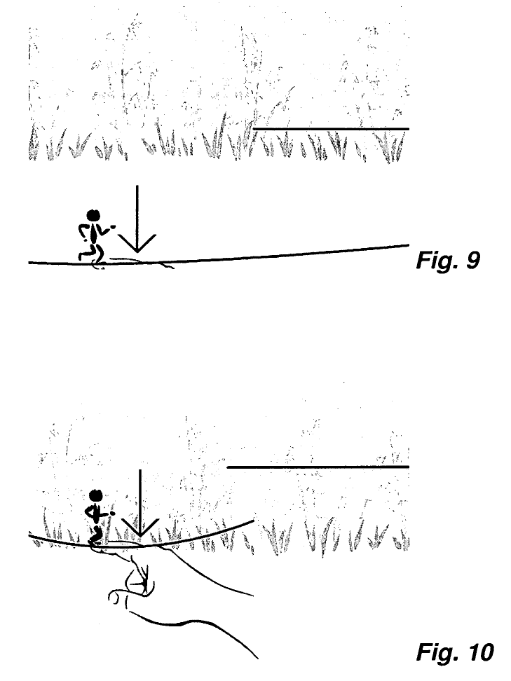

1) Mountains, as illustrated in FIGS. 1 and 2. A mountain stands in front of the character, blocking its path (FIG. 1). The user places his finger on the mountain and drags it down (FIG. 2) Flattening it and removing the obstacle.
2) Hole, as illustrated in FIGS. 3 and 4. A hole stands in front of the character (FIG. 3). The user drags the hole's edge sideways, closing the hole (FIG. 4).
3) Flying enemy, as illustrated in FIGS. 5 and 6. An airborne enemy flies across the top of the screen. The user has to drag down the line (FIG. 5) and release it (as if it was a rubber band), causing the character to fly through the air and bump into the enemy, destroying it (FIG. 6). If the user fails to do it the enemy will drop a heavy object on the character, making the user fail the level.
4) Rolling rock, as illustrated in FIGS. 7 and 8. A rock rolls towards the character (FIG. 7). The user has to lift the line in order to create a hill and make the rock roll down it (FIG. 8). If the user does not do it, the rock will roll over the character.
5) Gaps, as illustrated in FIGS. 9 and 10. The character will reach sections of the terrain where the line disappears, creating a gap. The user will need to drag down the line and release it (FIG. 9), making the character jump to a line situated above it. The user will then need to repeat the movement, making the character jump from line to line (FIG. 10), until it passes the gap and can lend safely on the ground.
6) Creating a hole. Some enemies will have unstable ground below them. This will be indicated by a different color or different texture of the line. If an enemy stands on unstable ground the user can make it collapse by swiping his finger downward at the unstable spot. This will cause a hole to form and the enemy to fall into it.

The above description of the Lineman game relates to a simple version which uses a single finger to input the gestures. It is of course possible, and it is within the scope of the invention, to use multi-finger inputs in order to allow for more complex gestures. For example:

1) Cliffs. The user will reach a high cliff. If the character falls down it will make the user fail the level. The user will need to grab the lowermost point of the cliff with one finger and the uppermost point of the cliffs with the other. The user will then twist the cliff sideways, flattening it and creating a flat plain.
2) Creating a cliff. Some enemies can be disposed of by making them fall off a cliff. To create a cliff the user will need to place two fingers on the line, one on each side of the enemy. The user will then twist the line in a reverse gesture to flattening a cliff. This will create a cliff and cause the enemy to fall and disappear.
3) Trapping an enemy. Some enemies can be trapped by the line they are standing on. The user will trap an enemy by putting two fingers on the line, one on each side of the enemy. The user will then bring the two fingers together, pinching the line between his fingers and making it into a pouch containing the enemy inside it.
4) Earthquake. A set number of times in each level, the user can use the earthquake attack. The user will put two fingers on the line, each on the opposite side of the screen and move his fingers up and down in opposite directions. This will create an earthquake that will make the entire game area shake, disposing of all enemies on screen.

The game can also be played by a number of players in a number of different modes. For example:

Competitive mode. Two players can play against each other via wireless, with one player manipulating the terrain to create obstacles in the character's path while the other manipulates the terrain to remove them.

Cooperative mode. Two players can play together via wireless, guiding the same character to the ends of the level. Obstacles can be divided between the two with some obstacles requiring the two players to make a gesture at the same time.

### Other Uses for the Gameplay:

The basic interaction that is made possible by the invention can be used in many different type of games. Illustrative examples include:

RACING: Instead of manipulating the car itself the user manipulates the terrain, making the car go faster if he raises a hill behind it or slower if he lowers the terrain to create a valley. The user can also raise the terrain on the sides of the car to make it turn left or right.

The same dynamic can be used in a 2-player racing game where one player tries to drive the car around an area while the other player manipulates the terrain in real time to create obstacles.

SKI: A character skies downhill while the player manipulates the world around it making it go faster and slower, dodge obstacles and go left and right.

STRATEGY GAME: The user can directly control the terrain of the level to make advancement of his opponents difficult. This can be either done in advance, with each side changing the terrain to create geographical obstacles or in real time with each user changing the terrain to trap (turn the flat plain they are standing on to a mountain or a deep valley) or put obstacles in his opponents way.

PUZZLE GAME: As a marble starts rolling the user has to manipulate the game world to guide it to the end of the level. Creating hills and craters, creating holes and bouncing the marble against the walls.

As will be apparent to the skilled person from the description given above, the invention provides a novel interaction method which affords a user experience which is much more intense than available according to the prior art.

All the above description of preferred embodiments has been provided for the purpose of illustration and is not intended to limit the invention in any way. Many modifications can be carried out to the above, without exceeding the scope of the invention.

1. A method of actuating a computer program that generates a dynamically changing graphic object on a touch screen, using a human finger, comprising identifying the object or the portion of an object which is being touched by said finger and thereafter virtually “attaching” said object or portion thereof to said finger so that a movement of said finger causes a change of shape, size or location of said object or portion thereof.

2. A method according to claim 1, wherein identifying the object or the portion of thereof comprises identifying the center of gravity of all the pixels of the touch screen, which are touched by the finger, and using said center of gravity as the anchoring point for performing the virtual attachment of the object to the finger.
